(19) United States
(12) Patent Application Publication
(10) Pub. No.: US 2003/0206543 A1
(43) Pub. Date: Nov. 6, 2003

(54) Partitioned medium access control

(76) Inventors: Michael Andrew Fischer, San Antonio, TX (US); Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/421,265

(22) Filed: Apr. 23, 2003

Related U.S. Application Data
(60) Provisional application No. 60/377,679, filed on May 3, 2002.

(51) Int. Cl. H04Q 7/24; H04J 3/24

(52) U.S. Cl. 370/338; 370/349

(57) ABSTRACT

A novel Medium Access Control (MAC) architecture for IEEE 802.11 wireless local area networks is disclosed. The illustrative embodiment partitions the medium access control into an Upper Medium Access Control for providing medium-access-control services that are independent of a Physical Control, and a Lower Medium Access Control for providing medium-access-control services that are dependent on the Physical Control. By partitioning the Medium Access Control in this manner, a single Upper Medium Access Control can be employed for any existing or future Physical Control while maintaining full compatibility with the huge installed base of existing IEEE 802.11 equipment. It will be clear to those skilled in the art how to make and use alternative embodiments of the present invention for networks that employ protocols other than IEEE 802. 11.

### CROSS-REFERENCE TO RELATED APPLICATIONS

This application claims the benefit of U.S. provisional application Ser. No. 60/377,679, filed May 3, 2002, entitled “Exposable Intra-MAC Interface For Wireless LANs,” (Attorney Docket: 680-038us), which is also incorporated by reference.

### FIELD OF THE INVENTION

The present invention relates to telecommunications in general, and, more particularly, to a novel medium access control architecture.

### BACKGROUND OF THE INVENTION

FIG. 1 depicts a schematic diagram of a wireless local area network in the prior art, which comprises: station 101-1, station 101-2, and station 101-3. Before stations 101-1, 101-2, and 101-3 can communicate with each other, there must be an agreement between the stations as to the meaning of the signals that they transmit. For example, the stations must agree on who talks when, what constitutes a “0” and a “1,” how is an error detected and corrected, etc. In the terminology of telecommunications, this agreement is called a protocol.

In a local area network a communications channel is shared among the stations such that if two or more of the stations transmit messages simultaneously via the shared channel, the messages can become corrupted. Consequently, a local area network protocol must include a mechanism for ensuring that only one station at a time can transmit into the shared-communications channel. This mechanism, which is known as a Medium Access Control, might also provide additional services such as encryption, authentication, and quality of service (QoS) provisioning, as well as management of certain non-communication functions such as power conserving operational states.

### SUMMARY OF THE INVENTION

In wireless local area networks that conform to the Institute of Electrical and Electronics Engineers (IEEE) 802.11 standard, the Medium Access Control is theoretically decoupled from the mechanism for controlling the physical (i.e., radio) transmission and receipt of message signals (referred to throughout this specification as the “Physical Control”) but in practice the two are inextricably intertwined.

The present invention enables the partial decoupling of the Medium Access Control from the Physical Control. This is especially advantageous for IEEE 802.11 wireless networks because it enables the standardization, development, and implementation of some of the medium-access-control services to be decoupled from the standardization, development, and implementation of the Physical Control, while maintaining full compatibility with the installed base of existing 802.11 equipment. This decoupling can result in the savings of tens or hundreds of millions of dollars to semiconductor, computer, and networking companies.

In particular, the illustrative embodiment decouples some of the medium-access-control services from the Physical Control by bifurcating the Medium Access Control into (i) an Upper Medium Access Control that provides those medium-access-control services that are independent of the Physical Control, and (ii) a Lower Medium Access Control that provides those medium-access-control services that are dependent on the Physical Control.

Although in this specification the illustrative embodiment is disclosed in the context of IEEE 802.11 local area networks, it will be clear to those skilled in the art how to make and use alternative embodiments of the present invention—including wireline networks and wireless networks—that employ protocols other than IEEE 802.11 (e.g., IEEE P802.15.3, etc.).

The illustrative embodiment comprises: receiving a service data unit at an Upper Medium Access Control; and outputting a protocol data unit to a Lower Medium Access Control; wherein said protocol data unit is based on: (i) said service data unit, and (ii) a first medium-access-control service that is independent of the state of a Physical Control providing service to said Lower Medium Access Control; and wherein said Lower Medium Access Control provides a second medium-access-control service based on: (i) said protocol data unit, and (ii) the state of said Physical Control.

### BRIEF DESCRIPTION OF THE DRAWINGS

FIG. 1 depicts a schematic diagram of wireless local area network 100 in accordance with the prior art.

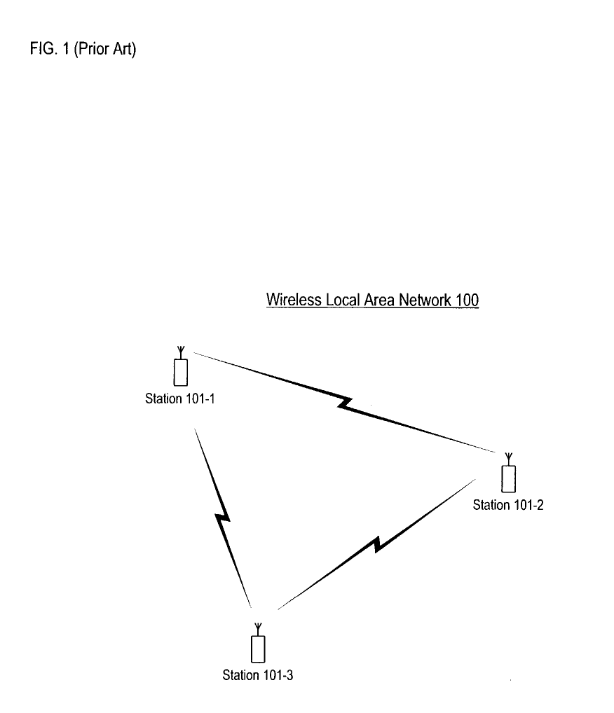

FIG. 2 depicts a conceptual architectural diagram of wireless station 101-i, as shown in FIG. 1, in accordance with the prior art.

FIG. 3 depicts a conceptual architectural diagram of a wireless station in accordance with the illustrative embodiment of the present invention.

FIG. 4 depicts a data-flow diagram of the illustrative embodiment of the present invention.

FIG. 5 depicts a block diagram of the salient components of Upper Medium Access Control 310, as shown in FIG. 3, in accordance with the illustrative embodiment of the present invention.

FIG. 6 depicts a device/control mapping for a wireless station in accordance with the illustrative embodiment of the present invention.

FIG. 7 depicts a block diagram of the salient components of Lower Medium Access Control 320, as shown in FIG. 3, in accordance with the illustrative embodiment of the present invention.

### DETAILED DESCRIPTION

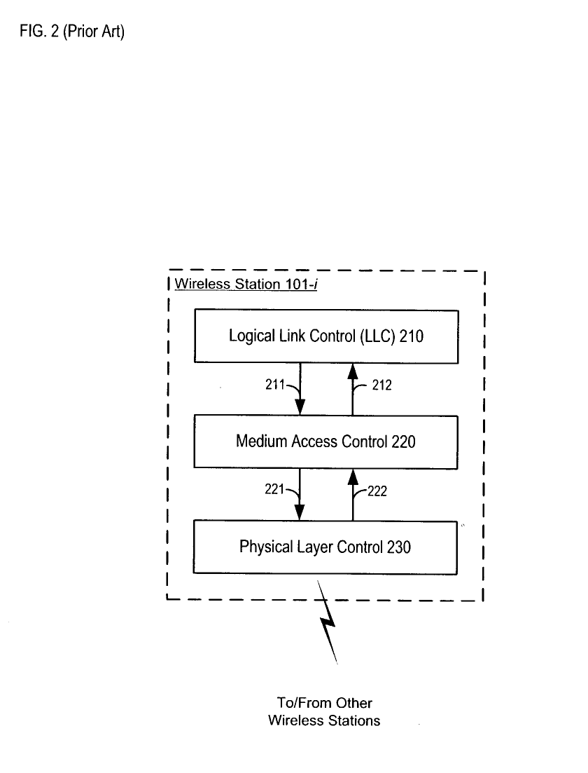

FIG. 2 depicts a conceptual architectural diagram of wireless station 101-i in accordance with the prior art. As shown in FIG. 2, wireless station 101-i comprises Logical Link Control (LLC) 210, Medium Access Control 220, and Physical Control 230, interconnected as shown.

Logical Link Control (LLC) 210 performs a variety of tasks such as multiplexing of packets from and demultiplexing of packets to a plurality of network layer entities with transfer of said packets occurring over the single data link provided by the underlying MAC+physical layer, and the establishment and maintainence of logical point-to-point connections over the shared data link, and/or the provision of acknowledgements for individual messages, on behalf of those network protcols needing such connection-oriented or acknowledged conectionless services, as is well-known in the art.

Medium Access Control 220 performs the channel access function, which ensures that only one station at a time can transmit signals onto the shared-communications channel, as well as frame addressing and detection, the generation and checking of frame check sequences, and LLC protocol data unit delimiting. In addition, Medium Access Control may provide additional services including encryption, authentication, and QoS provisioning, as well as related, non-communication functions such as power management, as is well-known in the art.

Physical Control 230 administers the physical transmission of signals to other stations and the physical receipt of signals from other stations via the network medium (e.g., radio, Ethernet, etc.), as is well-known in the art.

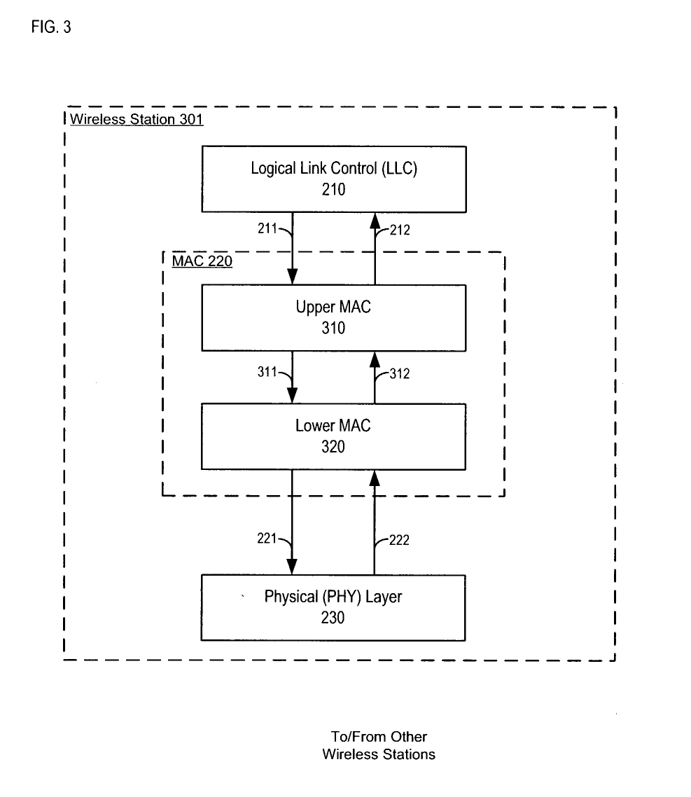

FIG. 3 depicts a conceptual architectural diagram of a wireless station in accordance with the illustrative embodiment of the present invention. As shown in FIG. 3, Medium Access Control 220 is partitioned into Upper Medium Access Control 310 and Lower Medium Access Control 320. Upper Medium Access Control 310 provides a subset of medium-access-control services that are independent of Physical Control 230, including transmit queueing, encryption, decryption, authentication, association, re-association, scanning, distribution, and traffic categorization (for the purposes of, for example but without limitation, quality-of-service (QoS) provisioning), as is well-known in the art. The Upper Medium Access Control may also perform those functions within MAC data service and MAC management service that are independent of Physical Control 230, including power management, queue management, duplicate detection and filtering, fragmentation, defragmentation, queue management.

Lower Medium Access Control 320 provides remaining medium-access-control services (i.e., those that are dependent on Physical Control 230), including channel access, receive validation (e.g., frame control sequence, forward error correction, etc.), and those that involve hard real-time functions and/or are physical layer-implementation dependent, such as response control (e.g., clear-to-send [CTS], acknowledgement [ACK], etc.), as are well-known in the art.

There are four criteria for determining which functions belong to lower medium access control 320:

i. Functions that are specific to a given physical layer or given type of physical layer;

ii. Functions that require knowledge of the internal state of the physical layer or knowledge of implementation-specific operational characteristics of the physical layer;

iii. Hard real-time functions necessary to generate conformant communication (signaling) sequences as viewed on the (wireless) medium; and

iv. Particular other functions that “belong” in the Lower Medium Access Control because of general implementation considerations, or because a party with sufficient clout (e.g., Microsoft, etc.) wants them to be there.

As shown in FIG. 3, Upper Medium Access Control 310 outputs data to Lower Medium Access Control 320 via path 311, and receives data from Lower Medium Access Control 320 via path 312. Similarly, Lower Medium Access Control 320 outputs data to Physical Control 230 via path 221, and receives data from Physical Control 230 via path 222. In some embodiments these two, logical paths may be multiplexed onto a single electrical or optical interconnection.

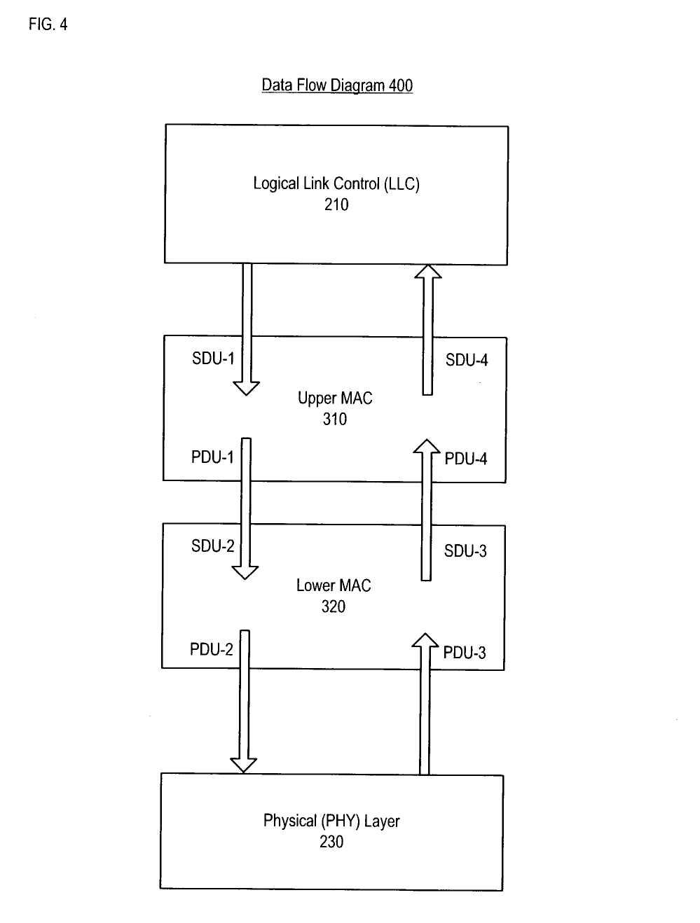

FIG. 4 depicts data-flow diagram 400 for the illustrative embodiment of the present invention. As shown in FIG. 4, Upper Medium Access Control 310 receives a service data unit (service data unit-1) from Logical Link Control 210; performs the appropriate functions with respect to service data unit-1 in accordance with the requested service (i.e., functions without hard real-time constraints and independent of Physical Control 230), as is well-understood in the art; generates a protocol data unit (protocol data unit-1); and outputs protocol data unit-1, accompanied in some cases by control information (e.g. desired transmit data rate and/or modulation, packet lifetime or retry limits, transmission priority, etc.) to Lower Medium Access Control 320. Lower Medium Access Control 320 receives protocol data unit-1 as a service data unit (service data unit-2); performs the appropriate functions with respect to service data unit-2 in accordance with the requested service (i.e., functions with hard real-time constraints and/or dependent on Physical Control 230); generates protocol data unit protocol data unit-2; and outputs protocol data unit-2 and associated control information (e.g. channel selection, modulation type, preamble length, etc.) to Physical Control 230.

Physical Control 230 transmits an outgoing signal based on protocol data unit2 and receives an incoming signal (e.g., acknowledgement [ACK], etc.), as is well-known in the art, and outputs data and reception status (e.g. received signal strength, signal quality, modulation utilized by sender, etc.) based on the incoming signal to Lower Medium Access Control 320. Lower Medium Access Control 320 receives the outputted data from Physical Control 230 as protocol data unit protocol data unit-3; performs the appropriate functions with respect to protocol data unit-3 and associated reception status in accordance with the indicated service; generates service data unit service data unit-3; and outputs service data unit-3 to Upper Medium Access Control 310. Upper Medium Access Control 310 receives service data unit-3 from Lower Medium Access Control 320 as protocol data unit protocol data unit-4; performs the appropriate functions with respect to protocol data unit-4 in accordance with the indicated service; generates service data unit service data unit-4; and outputs service data unit-4 to Logical Link Control 210.

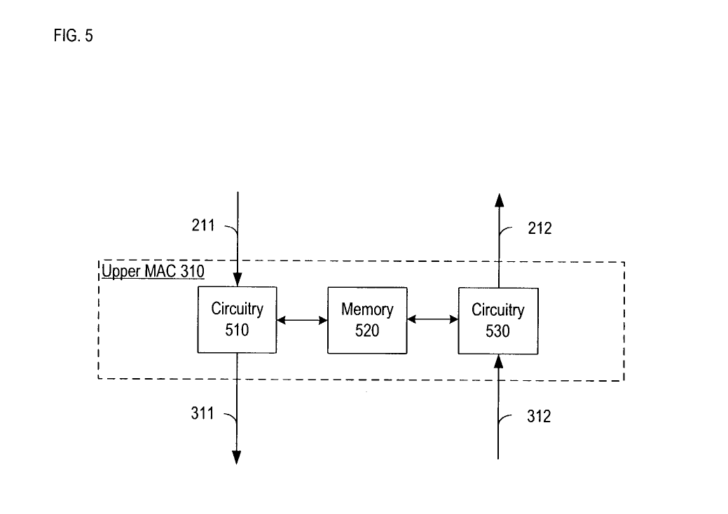

FIG. 5 depicts a block diagram of the salient components of Upper Medium Access Control 310 in accordance with the illustrative embodiment of the present invention. As depicted in FIG. 5, Upper Medium Access Control 310 comprises circuitry 510, memory 520, and circuitry 530, interconnected as shown. It will be clear to those skilled in the art, after reading this specification, that in some alternative embodiments of the present invention, Upper Medium Access Control 310 is implemented either partially or entirely in software on a host computer's processor.

Circuitry 510 comprises standard combinational digital logic and/or analog electronic elements, as is well-known in the art. Combinational digital logic of circuitry 510 writes to and reads from memory 520 in well-known fashion, thereby providing state-based services. Circuitry 510, in accordance with data flow diagram 400, receives data via input 211, performs the appropriate functions without hard real-time constraints and independent of Physical Control 230, and outputs data and control information to Lower Medium Access Control 320 via output 311.

Memory 520 is a random-access memory that stores data for circuitry 510 and circuitry 530; it will be clear to those skilled in the art how to make and use memory 520.

Circuitry 530 comprises standard combinational digital logic, which writes to and reads from memory 520 in well-known fashion, and/or analog electronic elements, as is well-known in the art. In accordance with data flow diagram 400, circuitry 530 receives data and status from Lower Medium Access Control 320 via input 312, performs the appropriate functions without hard real-time constraints and independent of Physical Control 230, and outputs data to Logical Link Control 210 via output 212.

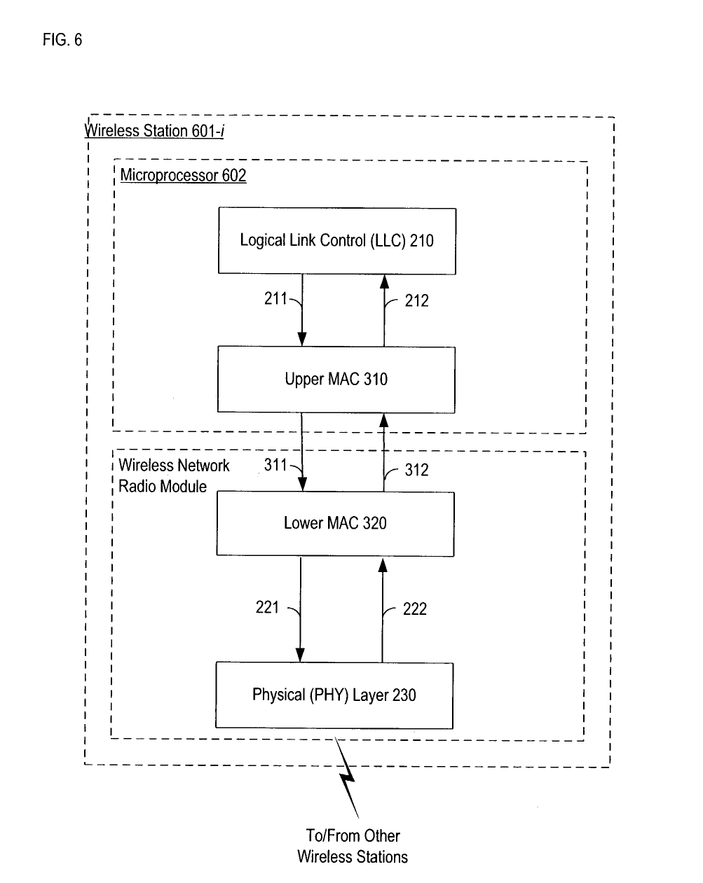

FIG. 6 depicts a device/control mapping for a wireless station 601-i in accordance with the illustrative embodiment of the present invention. As shown in FIG. 6, wireless station 601-i comprises microprocessor 602 for implementing the functions of Upper Medium Access Control 310 and Logical Link Control 210. As will be clear to those skilled in the art, some other embodiments of the present invention might employ alternative device/control mappings (e.g., implementing Upper Medium Access Control 310 outside microprocessor 602, etc.), and it will be clear to those skilled in the art how to make and use such embodiments.

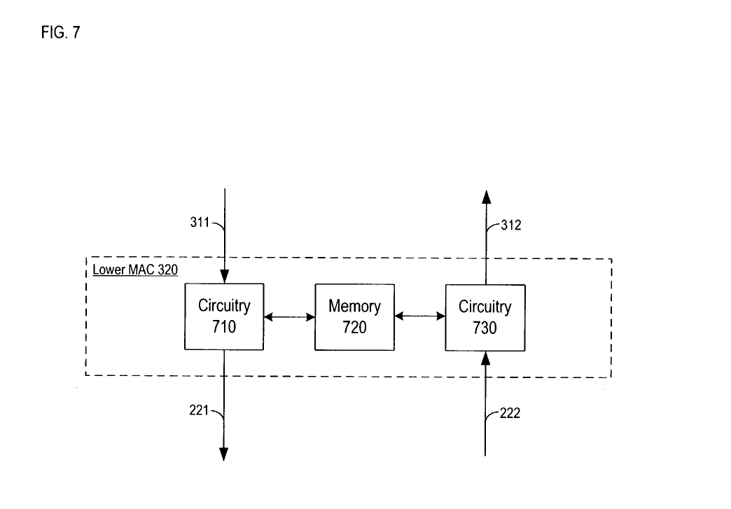

FIG. 7 depicts a block diagram of the salient components of Lower Medium Access Control 320 in accordance with the illustrative embodiment of the present invention. As depicted in FIG. 7, Lower Medium Access Control 320 comprises circuitry 710, memory 720, and circuitry 730, interconnected as shown. It will be clear to those skilled in the art, after reading this specification, that in some alternative embodiments of the present invention, Lower Medium Access Control 320 is implemented either partially or entirely in firmware.

Circuitry 710 comprises standard combinational digital logic and/or analog electronic elements, as is well-known in the art. Combinational digital logic of circuitry 710 writes to and reads from memory 720 in well-known fashion, thereby providing state-based services. Circuitry 710, in accordance with data flow diagram 400, receives data via input 411, performs the appropriate functions dependent on Physical Control 230, and outputs data to Physical Control 230 via output 221.

Memory 720 is a random-access memory that stores data for circuitry 710 and circuitry 730; it will be clear to those skilled in the art how to make and use memory 720.

Circuitry 730 comprises standard combinational digital logic, which writes to and reads from memory 720 in well-known fashion, and/or analog electronic elements, as is well-known in the art. In accordance with data flow diagram 400, circuitry 730 receives data from Physical Control 230 via input 222, performs the appropriate functions dependent on Physical Control 230, and outputs data to Upper Medium Access Control 310 via output 312.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
receiving a service data unit at an Upper Medium Access Control; and
outputting a protocol data unit to a Lower Medium Access Control;
wherein said protocol data unit is based on:
(i) said service data unit, and
(ii) a first medium-access-control service that is independent of the state of a Physical Control providing service to said Lower Medium Access Control; and
wherein said Lower Medium Access Control provides a second medium-access-control service based on:
(i) said protocol data unit, and
(ii) the state of said Physical Control.

2. The method of claim 1 further comprising:
receiving a second protocol data unit at said Lower Medium Access Control from said Physical Control; and
outputting a second service data unit to said Upper Medium Access Control.

3. The method of claim 1 wherein said first medium-access-control service is transmit queueing.

4. The method of claim 1 wherein said second medium-access-control service is channel access.

5. A method comprising:
receiving a service data unit at an Upper Medium Access Control that provides a first medium-access-control service; and
outputting a protocol data unit to a Lower Medium Access Control that provides a second medium-access-control service;
wherein said first medium-access-control service is independent of any physical attribute of all signals transmitted or received by a Physical Control providing service to said Lower Medium Access Control; and
wherein said second medium-access-control service is dependent on a physical attribute of a signal transmitted or received by said Physical Control.

6. The method of claim 5 further comprising:
receiving a second protocol data unit at said Lower Medium Access Control from said Physical Control; and
outputting a second service data unit to said Upper Medium Access Control.

7. The method of claim 5 wherein said first medium-access-control service is transmit queueing.

8. The method of claim 5 wherein said second medium-access-control service is channel access.

9. A method comprising:
receiving a service data unit from an Upper Medium Access Control; and
outputting a protocol data unit to a Physical Control;
wherein said Physical Control provides a first medium-access-control service that is independent of the state of said Physical Control; and
wherein said protocol data unit is based on:
(i) said service data unit, and
(ii) a second medium-access-control service that depends on the state of said Physical Control.

10. The method of claim 9 further comprising:
receiving a second protocol data unit from said Physical Control; and
outputting a second service data unit to said Upper Medium Access Control.

11. The method of claim 9 wherein said first medium-access-control service is transmit queueing.

12. The method of claim 9 wherein said second medium-access-control service is channel access.

13. A method comprising:
receiving a service data unit from an Upper Medium Access Control that provides a first medium-access-control service; and
outputting a protocol data unit to a Physical Control;
wherein said first medium-access-control service is independent of any physical attribute of all signals transmitted or received by said Physical Control; and
wherein said protocol data unit is based on:
(i) said service data unit, and
(ii) a second medium-access-control service that is dependent on a physical attribute of a signal transmitted or received by said Physical Control.

14. The method of claim 13 further comprising:
receiving a second protocol data unit from said Physical Control; and
outputting a second service data unit to said Upper Medium Access Control.

15. The method of claim 13 wherein said first medium-access-control service is transmit queueing.

16. The method of claim 13 wherein said second medium-access-control service is channel access.

17. An integrated circuit comprising:
a microprocessor for generating a message to be transmitted to a remote station via a service data unit;
circuitry for:
generating a protocol data unit based on said service data unit, and
providing a first medium-access-control service; and
an output for outputting said protocol data unit to a first circuit comprising:
a Physical Control, and
a second circuit for providing a second medium-access-control service;
wherein said first medium-access-control service is independent of the state of said Physical Control; and
wherein said second medium-access-control service is dependent on the state of said Physical Control.

18. The integrated circuit of claim 17 wherein said first medium-access-control service is transmit queueing.

19. The integrated circuit of claim 17 wherein said second medium-access-control service is channel access.

20. A wireless station comprising:
a microprocessor for generating an outgoing message to be transmitted to a remote wireless station via a service data unit;
a first circuit for:
providing a first medium-access-control service, and
generating a first protocol data unit based on said service data unit;
a second circuit for:
providing a second medium-access-control service, and
generating a second protocol data unit based on said first protocol data unit; and
a Physical Control for:
generating a third protocol data unit based on said second protocol data unit, and
transmitting a signal based on said third protocol data unit to said remote wireless station;
wherein said first medium-access-control service is independent of the state of said Physical Control; and
wherein said second medium-access-control service is based on the state of said Physical Control.

21. The wireless station of claim 20 wherein said Physical Control is also for:
receiving a second signal from said remote wireless station, and
generating a second service data unit based on said second signal;
wherein said second circuit is also for generating a third service data unit based on said second service data unit;
wherein said first circuit is also for generating a fourth service data unit based on said third service data unit; and
wherein said microprocessor is also for receiving an incoming message from said remote wireless station via said fourth service data unit.

22. The wireless station of claim 20 wherein said first medium-access-control service is transmit queueing.

23. The wireless station of claim 20 wherein said second medium-access-control service is channel access.

24. A wireless network radio module comprising:
a Physical Control; and
a first circuit for receiving a service data unit from an Upper Medium Access Control and for outputting a protocol data unit to said Physical Control;
wherein said Physical Control provides a first medium-access-control service that is independent of the state of said Physical Control; and
wherein said protocol data unit is based on:
(i) said service data unit, and
(ii) a second medium-access-control service that depends on the state of said Physical Control.

25. The wireless network radio module of claim 24 further comprising:
a second circuit for receiving a second protocol data unit from said Physical Control and for outputting a second service data unit to said Upper Medium Access Control.

26. The wireless network radio module of claim 24 wherein said first medium-access-control service is transmit queueing.

27. The wireless network radio module of claim 24 wherein said second medium-access-control service is channel access.

28. A wireless network radio module comprising:
a Physical Control; and
a first circuit for receiving a service data unit from an Upper Medium Access Control that provides a first medium-access-control service and outputting a protocol data unit to a Physical Control;
wherein said first medium-access-control service is independent of any physical attribute of all signals transmitted or received by said Physical Control; and
wherein said protocol data unit is based on:
(i) said service data unit, and
(ii) a second medium-access-control service that is dependent on a physical attribute of a signal transmitted or received by said Physical Control.

29. The wireless network radio module of claim 28 further comprising:
a second circuit for receiving a second protocol data unit from said Physical Control and outputting a second service data unit to said Upper Medium Access Control.

30. The wireless network radio module of claim 28 wherein said first medium-access-control service is transmit queueing.

31. The wireless network radio module of claim 28 wherein said second medium-access-control service is channel access.
